(19) United States
(12) Patent Application Publication
(10) Pub. No.: US 2013/0115483 A1
(43) Pub. Date: May 9, 2013

(54) SHIELD FOR HIGH-TEMPERATURE ELECTROCHEMICAL DEVICE

(71) Applicant: Point Source Power, Inc., Alameda, CA (US)

(72) Inventors: Michael Cook Tucker, Berkeley, CA (US); Craig Peter Jacobson, Moraga, CA (US)

(73) Assignee: POINT SOURCE POWER, INC., Alameda, CA (US)

(21) Appl. No.: 13/658,556

(22) Filed: Oct. 23, 2012

Related U.S. Application Data
(60) Provisional application No. 61/551,080, filed on Oct. 25, 2011.
(60) Provisional application No. 61/551,081, filed on Oct. 25, 2011.
(60) Provisional application No. 61/551,083, filed on Oct. 25, 2011.

(51) Int. Cl. H01M 8/02

(52) U.S. Cl. CPC H01M 8/0271
USPC 429/9; 429/508; 429/468

(57) ABSTRACT

A system includes a fuel cell having a fuel electrode and an oxygen electrode. A shield is configured to be on the oxygen electrode side of the fuel cell and an air chamber is configured to be on the oxygen electrode side of the fuel cell. The air chamber is formed at least in part by the shield. A fuel chamber is configured to be on the fuel electrode side of the fuel cell where the fuel chamber is configured to hold solid fuel.

CROSS REFERENCE TO OTHER APPLICATIONS

This application claims priority to U.S. Provisional Patent Application No. 61/551,080 (Attorney Docket No. PSPIP002+) entitled POWER SYSTEM COMPRISING FUEL CELL AND HANDLE filed Oct. 25, 2011, U.S. Provisional Patent Application No. 61/551,081 (Attorney Docket No. PSPIP003+) entitled SHIELD FOR HIGH-TEMPERATURE ELECTROCHEMICAL DEVICE filed Oct. 25, 2011 and U.S. Provisional Patent Application No. 61/551,083 (Attorney Docket No. PSPIP004+) entitled FUEL CELL MODULE WITH FOLDED SHEET METAL CHAMBERS filed Oct. 25, 2011 which are incorporated herein by reference for all purposes.

### BACKGROUND OF THE INVENTION

Fuel cell systems (such as solid oxide fuel cell systems) use heat, oxygen, and fuel to generate electrical power. Fuel cell systems typically operate in controlled environments where purified, gaseous fuels are piped in. The environment is typically sealed so that gases or materials (e.g., other than the gaseous fuel and oxygen) do not contaminate the system and/or the flow rate of the gaseous fuel and/or oxygen introduced is carefully controlled (e.g., using valves). New fuel cell systems which are able to be used in a wider range of environments and/or conditions are being developed for campers, hunters, and others who find themselves away from a power grid. Unfortunately, uncontrolled environments may cause damage to a fuel cell system and/or may cause a fuel cell system to perform poorly. Devices which protect fuel cell systems and/or improve performance in uncontrolled environments would be desirable.

### BRIEF DESCRIPTION OF THE DRAWINGS

Various embodiments of the invention are disclosed in the following detailed description and the accompanying drawings.

FIG. 1 is a diagram showing an embodiment of a fuel cell system with a shield where the fuel cell system is configured to operate in a hot zone.

FIG. 2 is a graph showing an embodiment of fuel cell system performance with and without a shield.

FIG. 3 is a diagram showing embodiments of a shield connected to a fuel cell system in a variety of ways.

FIG. 4 is a diagram showing various embodiments of sealant placement.

FIG. 5 is a diagram showing an embodiment of a shield with air holes.

FIG. 6 is a diagram showing an embodiment of a fuel cell system where an air chamber is shared by multiple cells.

FIG. 7 is a diagram showing an embodiment of a fuel cell system where a fuel chamber is shared by multiple cells.

FIG. 8A is a diagram showing an embodiment of two types of foldable assemblies.

FIG. 8B is a diagram showing an embodiment of two types of foldable assemblies connected to two fuel cells prior to folding.

FIG. 8C is a diagram showing an embodiment of two types of foldable assemblies connected to two fuel cells and folded to form air chambers and fuel chambers.

FIG. 9 is a diagram of a first type of a foldable assembly with a plurality of holes.

FIG. 10 is a diagram showing an embodiment of an assembly in which the fuel cells are orientated at an angle.

FIG. 11 is a diagram showing various embodiments of sealant placement used to attach fuel cells to two types of a flexible assembly.

FIG. 12 is a diagram showing an embodiment of a power conditioning removable attachment which is connected to a fuel cell system.

FIG. 13 is a diagram showing some embodiments of power conditioning.

### DETAILED DESCRIPTION

The invention can be implemented in numerous ways, including as a process; an apparatus; a system; and/or a composition of matter. In this specification, these implementations, or any other form that the invention may take, may be referred to as techniques. In general, the order of the steps of disclosed processes may be altered within the scope of the invention. Unless stated otherwise, a component described as being configured to perform a task may be implemented as a general component that is temporarily configured to perform the task at a given time or a specific component that is manufactured to perform the task.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An electrochemical device is capable of deriving electrical energy from chemical reactions and/or facilitating chemical reactions through the introduction of electrical energy. One type of electrochemical device is a solid oxide fuel cell. Solid oxide fuel cells are high temperature fuel cells that use heat, oxygen, and (e.g., gaseous) fuel to generate electrical power from chemical reactions. Oxygen may be obtained from the air, gaseous fuel may be released from solid fuel (e.g., when the solid fuel is heated), and heat may be obtained from an external heat source (e.g., a fire, cooking stove, heat exchanger, boiler, furnace, engine, nuclear power facility, concentrated solar device, etc.).

In some cases, the air within or amidst a heat source (e.g., the air residing amongst hot coals in a fire) may be contaminated. These contaminants may cause damage to an oxygen electrode (e.g., the cathode), seal, current collector, catalyst, or other exposed component of the fuel cell system. This damage may in turn cause the performance of the fuel cell system to degrade to an unacceptable degree. This is of particular concern when the heat source is a fire that utilizes biomass, wood, charcoal, coal, or waste products as fuel. These fuel sources contain K, Cl, S, As, P, Na, Ca, and other elements other than C, H, O, and N. These elements may form volatile species in a fire and may be transported to the fuel cell system by vapor, liquid, or direct contact, where they degrade the fuel cell system. It would be desirable to protect the sensitive components of a fuel cell system from this.

A fuel cell system which includes a fuel cell (having a fuel electrode and an oxygen electrode), a shield, an air chamber (on the oxygen electrode side of the fuel cell and formed at least in part by the shield), and a fuel chamber (configured to hold solid fuel and configured to be on the fuel electrode side of the fuel cell) is described herein. In at least some applications, a shield is useful because it protects and/or extends the lifetime of a fuel cell system. For example, a shield prevents too-hot pieces of charcoal (i.e., the heat source) from making contact with the oxygen electrode of a fuel cell. In another example, a shield prevents contaminants from coming into contact with the oxygen electrode of the fuel cell. In some embodiments, a shield forms part of an air chamber and another panel (which has an opening or a plurality of holes) further forms part of the air chamber. The opening or plurality of holes may permit air flow to the oxygen electrode of the fuel cell from the air chamber and improves the performance of a fuel cell system.

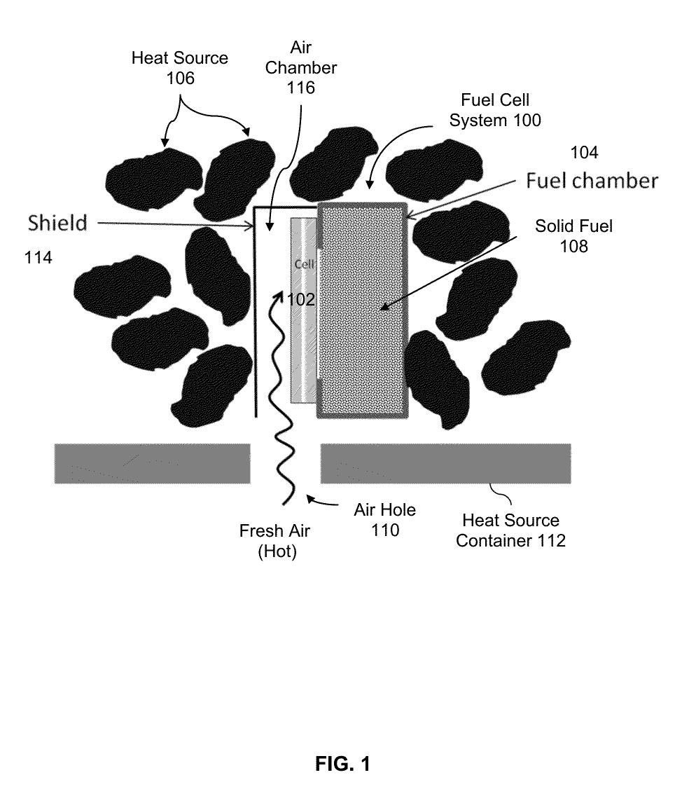

FIG. 1 is a diagram showing an embodiment of a fuel cell system with a shield where the fuel cell system is configured to operate in a hot zone. In the example shown, cell 102 (also referred to as a fuel cell) is a metal-supported solid oxide fuel cell. Fuel cell system 100 includes cell 102, shield 114, and fuel chamber 104. Cell 102 includes an oxygen electrode and a fuel electrode. Shield 114 is on the oxygen electrode side of cell 102 and fuel chamber 104 is on the fuel electrode side of cell 102. Air chamber 116 is formed between the oxygen electrode side of cell 102 and shield 114. Fuel chamber 104 is configured to hold solid fuel (e.g., manufactured fuel blocks, scraps of wood, animal dung, etc.). The solid fuel held in fuel chamber 104 releases gaseous fuels when the solid fuel is exposed to heat and the gaseous fuels are used in the electrochemical reaction to produce electrical power.

In this example, fuel cell system 100 is placed inside a cook stove and covered with heat source 106 (e.g., charcoal or other fuel for a fire). When heat source 106 is lit, the temperature of fuel cell system 100 rises to a temperature that promotes the production of gaseous fuels (e.g., H₂ and CO) from solid fuel 108 in fuel chamber 104. In some embodiments, solid fuel 108 is a biomass or charcoal, and/or is scavenged at a camp site (e.g., bits of wood or animal dung). In some embodiments, solid fuel 108 is a manufactured fuel block.

The gaseous fuel(s) released by solid fuel 108 participate in an electrochemical reaction between the gaseous fuel (e.g., at the fuel electrode side of cell 102) and oxygen from the air (e.g., at the oxygen electrode side of cell 102). In one example, oxygen from the hot, fresh air rising up through air hole 110 in heat source container 112 (e.g., a jiko cook stove common to East Africa) is used in the electrochemical reaction. Shield 114 (at least in this example) is shaped so that there is an opening at the bottom of air chamber 116. To optimize performance, when fuel cell system 100 is placed in a cook stove or other container, the opening at the bottom of air chamber 116 is aligned with air hole 110. This permits hot, fresh air to have a straight path to the oxygen electrode side of cell 102 via air hole 110 in heat source container 112 and the bottom opening of fuel cell system 100. In general, the more oxygen there is, the better fuel cell system 100 performs.

In some embodiments, since hot air has a tendency to flow upwards, a fuel cell system is configured to be placed in a cook stove or other container with a cell oriented vertically (e.g., as is shown in FIG. 1). This may permit hot, fresh air from air hole 110 to flow along the entire oxygen electrode side of cell 102, increasing oxygen transfer or exposure to cell 102.

In a typical environment, the air between the pieces of heat source 106 contains less than ˜21% oxygen. Without shield 114 there would be no air chamber 116 and without air chamber 116 the oxygen electrode of cell 102 would be exposed to air containing less than ˜21% oxygen. In contrast, air chamber 116 (formed by shield 114) permits air with a higher concentration of oxygen to come into contact with the oxygen electrode of cell 102 thereby increasing electrical power generation.

The air between the pieces of heat source 106 may also contain combustion products (e.g., CO₂ and H₂O) and volatile species containing elements that originated from heat source 106. In one example, heat source 106 is a wood-based charcoal which (when analyzed by x-ray fluorescence (XRF)) is found to contain S, Cl, K, Ca, Fe, Br, and Sr as minor constituents. These elements can damage the oxygen electrode of cell 102 and/or delicate metal components of fuel cell system 100. Shield 114 reduces or eliminates the damaging transfer of deleterious elements. In some embodiments, shield 114 prevents or inhibits vapor transport of volatile elements to cell 102.

In some embodiments, shield 114 prevents direct contact of heat source 106 and cell 102. For example, burning charcoal pieces (one example of heat source 106) are extremely hot and could damage cell 102 if direct contact is made.

In some embodiments, shield 114 is metal and acts as a thermal conductor which distributes heat more evenly. For example, heat source 106 in one region may be much hotter than heat source 106 in another region and shield 114 acts to homogenize the temperature field across the cell 102. In some cases this protects a cell or other component of a fuel cell from being damaged from local overheating.

A shield may comprise any material that can withstand a heat source environment and does not contribute to degradation of the fuel cell system. Some example shield materials include clay, metal, glass, ceramic, and composites. Stainless steel is another example shield material. In some embodiments, 400-series stainless steel is used (such as 430, 434, 410, etc.) and some example thicknesses of 400-series stainless steel are in the 0.006 inch to 0.020 inch range. In embodiments where sheet metal is used, the shield may be fabricated by stamping, crimping, drawing, folding, laser-cutting, chemical etching, or other processes known in the art. In various embodiments, a shield is attached to the cell, fuel chamber, or cell assembly by welding, resistance (“spot”) welding, laser welding, crimping, clinching, sintering, brazing, bonding (with adhesives or glasses or ceramics), or other techniques known in the art. In some embodiments, a shield includes a coating. Such a coating may reduce oxidation or corrosion of the shield and/or improve the aesthetic appearance.

A shield may be configured such that it contains an opening or holes that allow for fresh air access to the cell. This provides oxygen to the cell for the electrochemical reaction, while minimizing introduction of volatile species from the environment of the burning charcoal. If the cooking stove contains ports to provide airflow to the fire, it is desirable to position the opening of the shield in the vicinity of a port such that the cell is exposed to fresh, uncontaminated air from outside the fire.

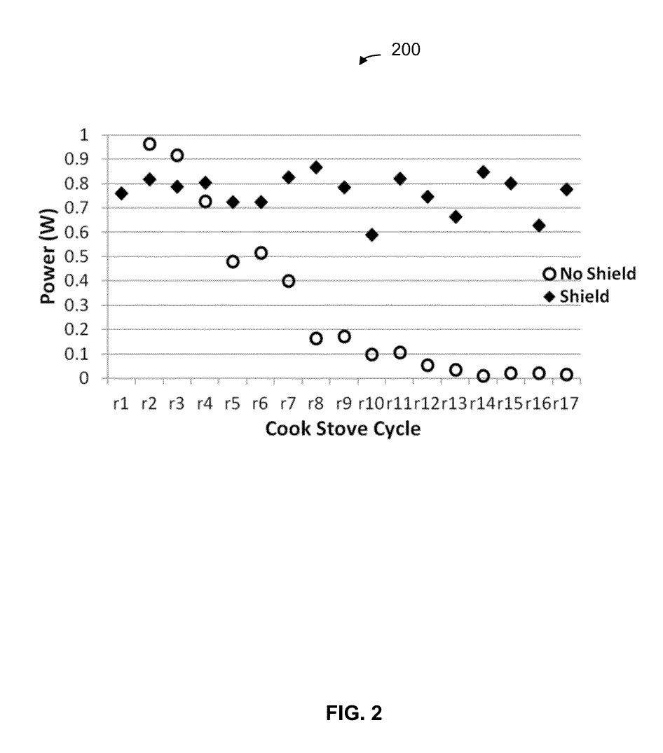

FIG. 2 is a graph showing an embodiment of fuel cell system performance with and without a shield. In the example shown, metal-supported solid oxide fuel cells of approximately 14 cm² area were attached to fuel chambers made of 430 stainless steel. The oxygen electrode of the fuel cells includes a porous 434 stainless steel current collector (or, more generally, a porous metal support), a porous yttria-stabilized zirconia (YSZ) electrode backbone, and an infiltrated electro-catalyst. Examples of electro-catalysts include metals, oxides, transition metals, mixtures of rare earth oxides and transition metals, perovskites, and other compositions known in the art. In the example shown, a mixture of rare earths and a transition metal comprising yttria-doped ceria and nickel (YDCN) electro-catalysts were infiltrated into the porous YSZ electrode backbone. One fuel cell system included a 430 stainless steel shield with a gap of approximately 4 mm between the shield and the cell. A second fuel cell system did not include a shield. Both cells were operated in a charcoal-burning cook stove (in this experiment, a ceramic jiko cook stove used in East Africa), in the configuration depicted in FIG. 1. Each operation run consisted of: filling the fuel chamber of the fuel cell system with charcoal powder; placing the fuel cell system in the bottom of the cook stove; filling the cook stove with wood charcoal; lighting the wood charcoal on fire; and recording the electric power provided by the cell assembly. Each run lasted approximately 2 hours. The maximum power achieved during each operation run was recorded and is shown in graph 200. The cell without a shield failed within about 10 runs. In contrast, the cell with a shield did not fail, and continued to supply power during many runs. That fuel cell system had a relatively small run-to-run variation in the power results. It is believed that the failure resulted from degradation of the oxygen electrode by contaminants from the charcoal fire environment.

In another example, a fuel cell system without a shield was operated in a charcoal-burning cook stove in the configuration depicted in FIG. 1. The electro-catalysts infiltrated into the porous YSZ electrode backbone was strontium doped lanthanum manganite, also known in the art as LSM. After failure, the cell was cross-sectioned and analyzed with SEM-EDAX microscopy. The stainless steel current collector showed significant corrosion/oxidation and contained K—Cr compounds. The electro-catalyst layer contained significant Cr, which is well known in the art to lead to degradation of the catalyst performance. It is believed that K migrated from the charcoal cooking fuel into the oxygen electrode. K (e.g., from the cooking fuel) and Cr (e.g., from the stainless steel) reacted to produce volatile K and/or Cr containing species. These species were reduced within the oxygen electrode to release K and deposit Cr. Thus, K from the cooking fuel acted as a shuttle for movement of Cr from the current collector (causing rapid oxidation of the steel) into the electrode (causing degradation of the electro-catalyst).

In one experiment using the fuel cell system with YDCN electro-catalysts and shield described above, the gap between the shield and the oxygen electrode side of the cell was varied. It was found that gaps of 3 mm or larger provided sufficient oxygen to the cell. Smaller gaps limited the oxygen flow to the cathode, resulting in reduced mass-transport-limited performance of the cell.

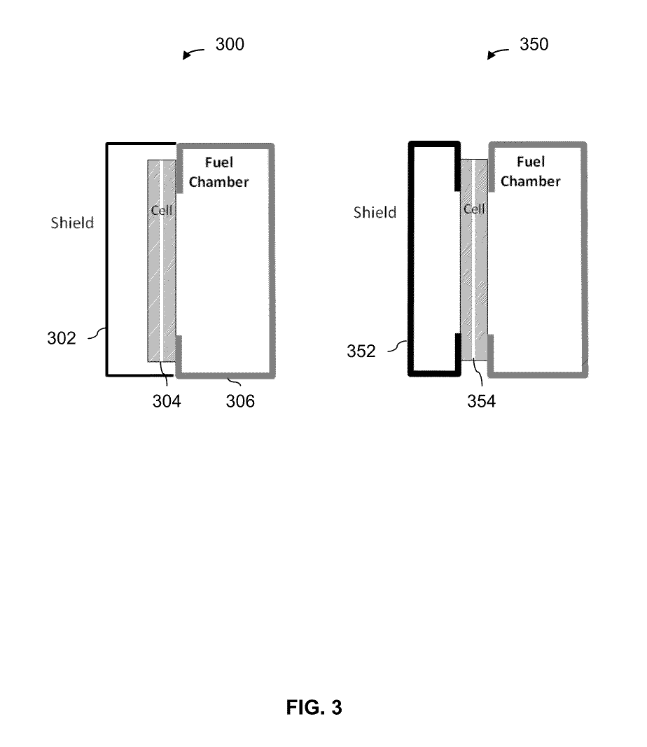

FIG. 3 is a diagram showing embodiments of a shield connected to a fuel cell system in a variety of ways. In fuel cell system 300, shield 302 is attached to fuel chamber 306, but not to cell 304. In fuel cell system 350, shield 352 is attached to the oxygen electrode of cell 354. In the case of electrically conductive shield and fuel chamber materials, the shield would be in electrical contact with the fuel electrode (e.g., anode) in the arrangement of fuel cell system 300, but in electrical contact with the oxygen electrode (e.g., cathode) in the arrangement of fuel cell system 350. A benefit of the arrangement of fuel cell system 350 is that multiple shield/cell/fuel chamber sub-assemblies can be easily connected in electrical series to build up voltage.

In the examples shown, fuel cell systems 300 and 350 are shown from a top view. In some embodiments, the bottom of an air chamber is open to permit air access.

The fuel cell system embodiments shown in this figure and other figures are merely exemplary and are not intended to be limiting. For example, dimensions (e.g., the thickness or length of a line) shown in these figures are not necessarily to scale and are not intended to be limiting. Any perceived difference, for example, in the thickness of the line used to draw shield 302 versus that of shield 352 does not necessarily correlate to differences in the thickness of the two shields. For clarity and brevity, some components of a fuel cell system (e.g., electrical leads connected to the anode and cathode, respectively) may not necessarily be shown in some figures.

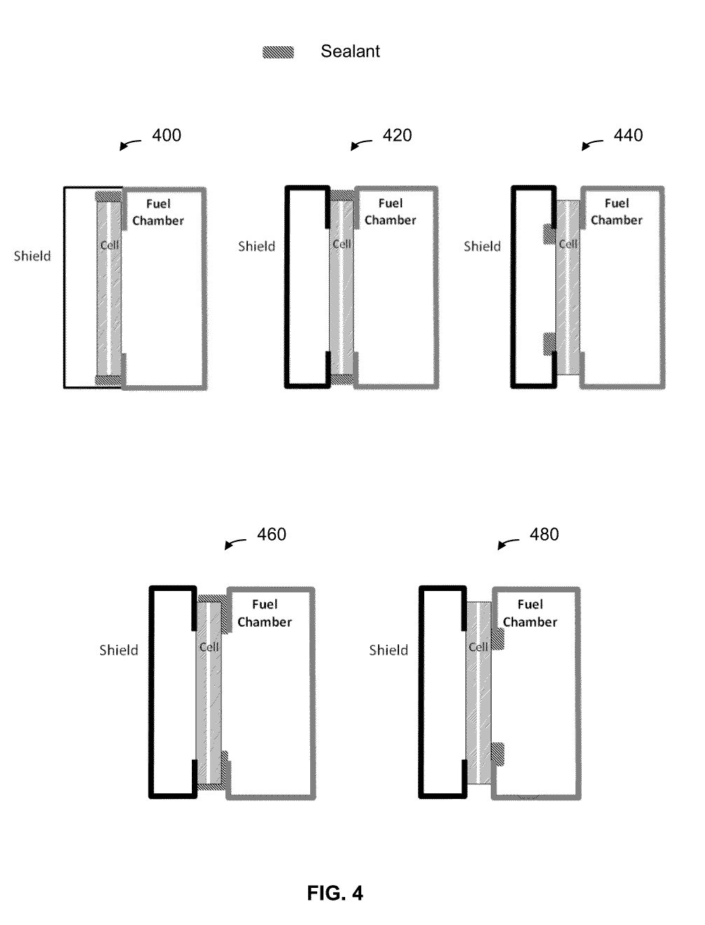

FIG. 4 is a diagram showing various embodiments of sealant placement. In the examples shown, fuel cell systems 400, 420, 440, 460, and 480 are shown from a top view. In some embodiments, the bottom of an air chamber is open to permit air access. In the examples shown, some options for placement of a seal are shown. In the examples shown, seal(s) is/are placed in the following configurations: touching the cell and fuel chamber (400); touching the cell, fuel chamber, and shield (420); touching the shield and cell (440); touching the cell, fuel chamber, and shield (460); and touching the cell and fuel chamber (480). Combinations of these configurations and other configurations are also possible. Configurations 420 and 460 are desirable in at least some applications because the seal protects the edge of the cell from contaminants in the heat source, and can improve mechanical integrity by preventing delamination of the cell layers. A preferred sealant is a calcium silicate glass (e.g. containing 4-5% Na₂O, 4-6% B₂O₃, 4-6% Al₂O₃, 16-20% CaO, and 55-65% SiO₂).

In some embodiments, a seal material is used to minimize intermixing of gases between a fuel chamber, air chamber, and/or heat source (e.g., the seal is air tight). In various embodiments, a seal provides mechanical strength at the perimeter of the fuel cell system and/or prevents a short circuit through the edges of the cell (e.g., the seal material is an electrical insulator).

In some embodiments, a seal is protected from the heat source by the shield. In some cases, the seal material may be damaged by the heat or chemical species in the fire. In some cases, the seal material is durable and is outside the shield (e.g., in direct contact with a heat source). A seal is not necessary and in some embodiments a fuel cell system does not include a seal.

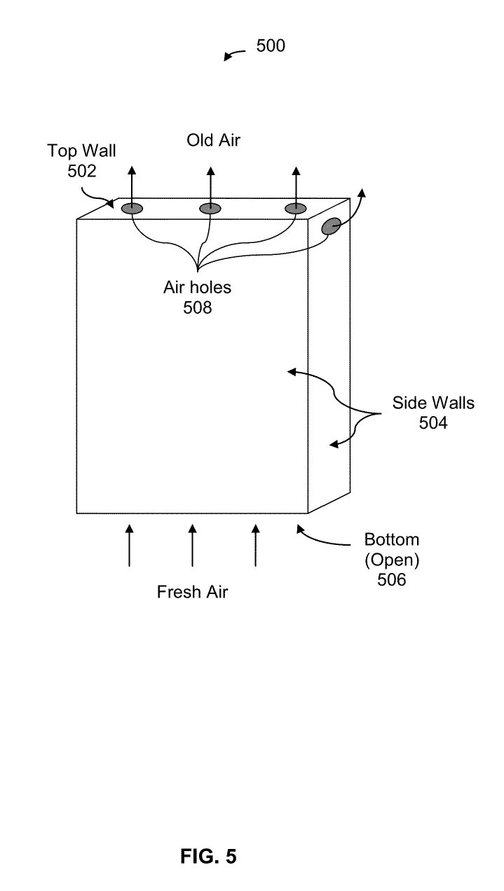

FIG. 5 is a diagram showing an embodiment of a shield with air holes. In the example shown, shield 500 includes air holes 508. In this example, some of air holes 508 are on top wall 502 and some are on side wall(s) 504. In this example, air holes 508 aid convection. Bottom 506 is open to allow the intake of fresh air. As the fresh air enters the air chamber, it is (further) heated by the heat source, increasing convection. Air holes 508 permit depleted air to escape the air chamber after the oxygen in the fresh air has been used in the electrochemical reaction. As such, in this example at least, the air holes that are located on the side of the shield are placed near the top. The number and placement of air holes shown in this example are not intended to be limiting.

In some embodiments, the number of air holes is limited to mitigate damage to the oxygen electrode side of a cell. For example, the more air holes there are, the likelier it is that a cell will be damaged by excessive heat, volatile species, and/or contaminants from a heat source environment, and so on. In some embodiments, an air hole is covered by a wire mesh. This permits depleted air to escape an air chamber but prevents too-hot pieces of charcoal from falling into the air chamber and damaging the oxygen electrode side of a cell.

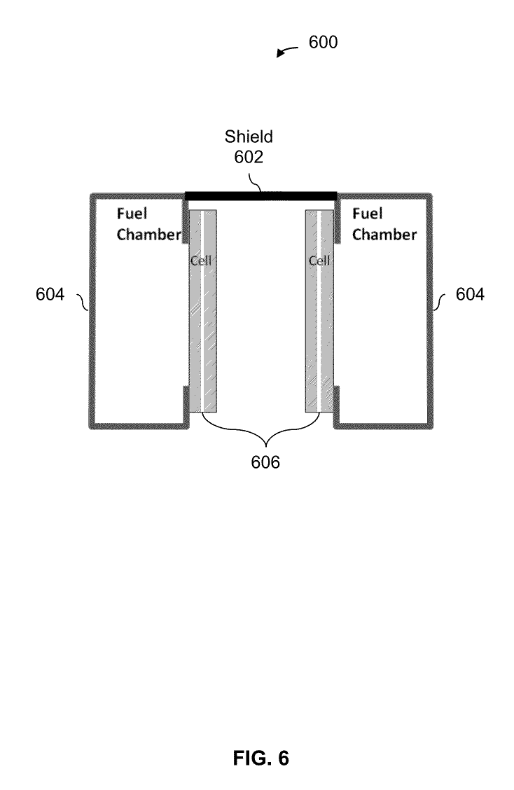

FIG. 6 is a diagram showing an embodiment of a fuel cell system where an air chamber is shared by multiple cells. In the example shown, fuel cell system 600 includes a single shield (602), two fuel chambers (604), and two cells (606). As is shown in this example, in some embodiments, a single shield is employed for multiple cells. In some embodiments, there is some electrical insulation (e.g., a seal made of an electrically insulated material or a gap) between the two fuel chambers 604 which prevents short-circuiting between the two electrodes of cells 606. In some embodiments, some combination of electrical insulators and/or connectors is used to connect cells 606 in electrical series if desired.

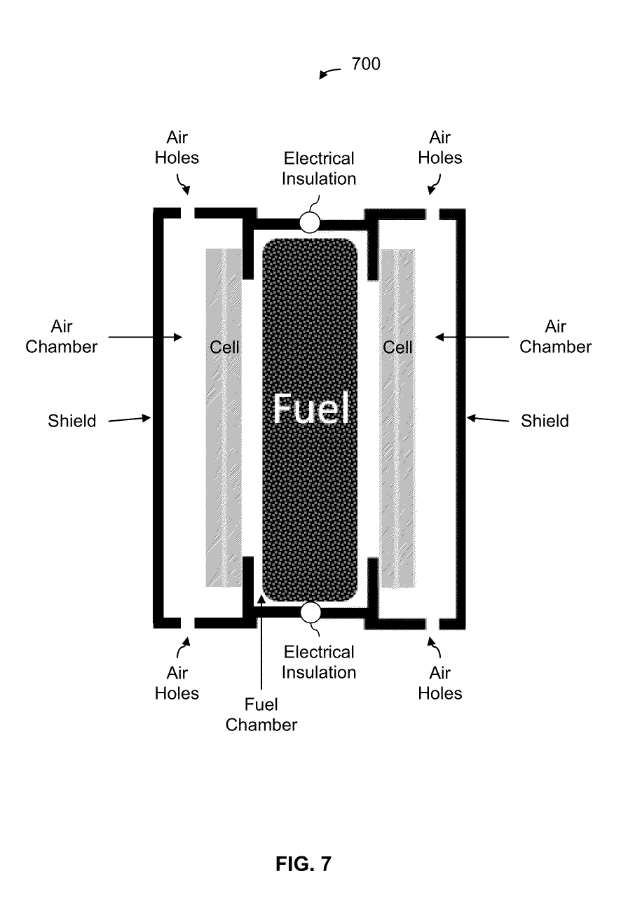

FIG. 7 is a diagram showing an embodiment of a fuel cell system where a fuel chamber is shared by multiple cells. In this example, two cells (each with their own respective shields) are connected to a single fuel chamber in system 700. In some embodiments, such a configuration simplifies fuel loading since only one lid (if used) needs to be opened and closed and/or only one fuel chamber needs be filled. In this example, electrical insulation (e.g., a seal made of electrically insulating material or a physical gap) prevents electrical shorting between the two fuel cells. Thus, the cells may be connected in series by, for example, wires attached to the shields and fuel chambers.

In some embodiments, a fuel cell system includes an assembly (sometimes referred to as a frame) which is able to be folded from a flat shape into a 3D shape in which the air chamber and fuel chamber are formed. For example, during the manufacturing process, the assembly may be shipped in the flat shape from an assembly manufacturing facility to a fuel cell system assembly facility. At the fuel cell system assembly facility, the assembly is folded from the flat shape into the 3D shape. The air chamber and fuel chamber (at least in some embodiments) are formed by folding one or more assemblies into a 3D shape (i.e., the walls of the fuel chamber, the walls of the air chamber, and the shield are part of the assembly). Other components (e.g., the fuel cell(s), electrical connections to the anode and cathode, sealant, electrical insulation, etc.) are then connected to the folded assembly at the fuel cell system assembly center. Using a foldable assembly may be attractive because it minimizes volume (e.g., when flat) for transport and storage. This may in turn reduce transportation and/or storage costs. The following figures describe some embodiments of foldable assemblies.

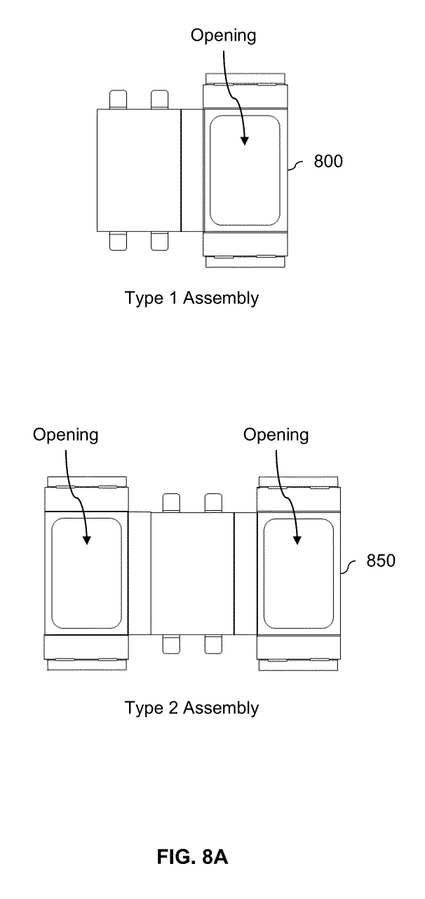

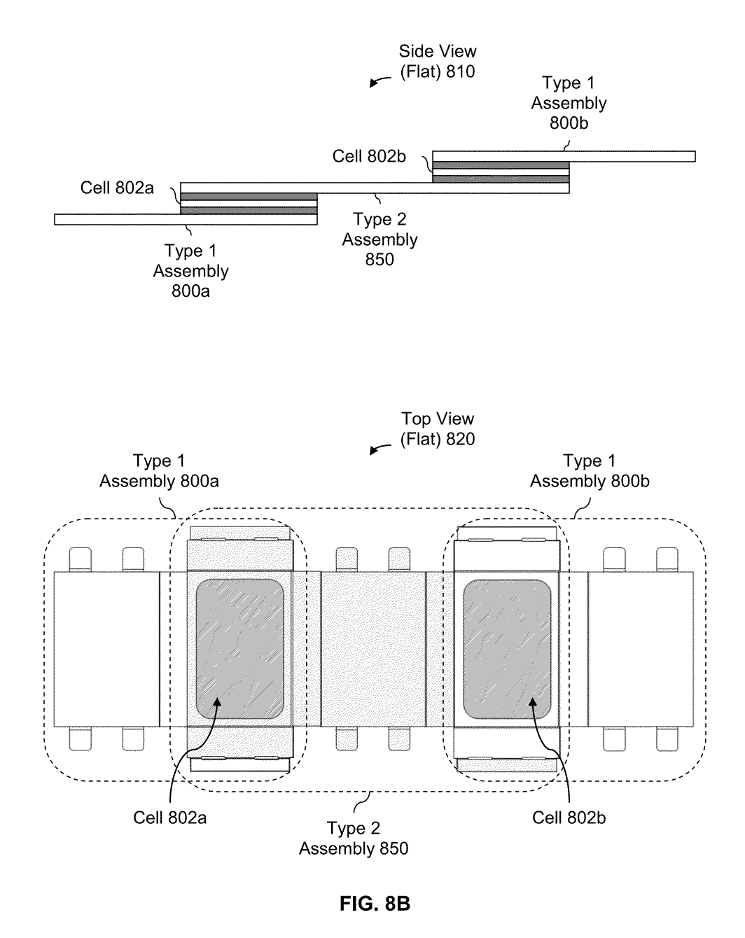

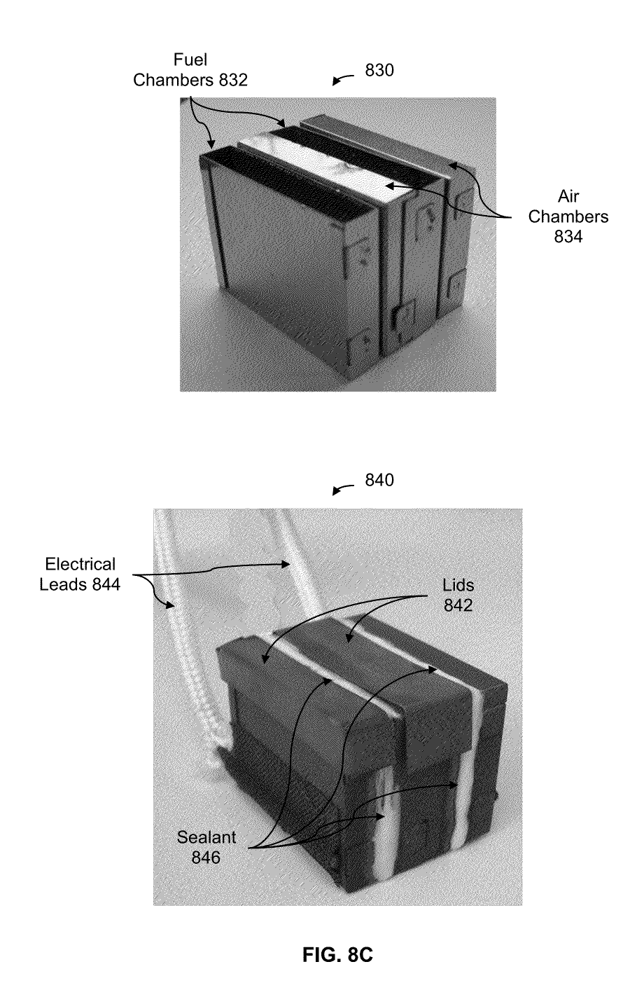

FIG. 8A is a diagram showing an embodiment of two types of foldable assemblies. In the example shown, assembly 800 is a first type of assembly and assembly 850 is a second type of assembly. In this figure, assemblies 800 and 850 are shown flat, but they are able to be folded into a 3D shape. The following figures show an example of how the two types of assemblies are bent to form one or more air chambers and one or more fuel chambers of a fuel cell system.

In some embodiments, chemical etching is used to create bend lines where assemblies 800 and 850 are bent. Bend lines aid in folding the assembly, for example during the manufacturing process. Any appropriate technique may be used to create bend lines (e.g., cutting the bend lines into an assembly using a laser, drill or saw).

As shown in this example, in some embodiments, assemblies are modular. Modular, foldable assemblies may be attractive because they permit fuel cell systems with variable numbers of fuel cells to be built.

FIG. 8B is a diagram showing an embodiment of two types of foldable assemblies connected to two fuel cells prior to folding. FIG. 8B is a continuation of the example shown in FIG. 8A. The drawing shown is merely illustrative and is not intended to be limiting with respect to the order in which manufacturing steps are performed. For example, any of assemblies 800a, 800b, or 850 may be folded first prior to being connected to cells 802a or 802b.

As shown in side view 810, a type 1 assembly (800a) is connected to a first fuel cell (802a). The other side of fuel cell 802a is in turn connected to a type 2 assembly (850). The other side of type 2 assembly 850 is connected to a second fuel cell (802b). The other side of second fuel cell 802b is in turn connected to a second type 1 assembly (800b). As such, in this example there are two type 1 assemblies (800a and 800b), two fuel cells (802a and 802b), and one type 2 assembly 850. In this example, fuel cells 802a and 802b are connected in electrical series. Put another way, the orientation of fuel cells 802a and 802b matches so that the air (fuel) electrode sides of the two cells are both facing down (up).

Although this example shows two fuel cells, any number of fuel cells may be connected together in series (e.g., to output a desired voltage). Similarly, any number of fuel cells may be connected together in parallel (e.g., to output a desired current). Some examples include connecting 2, 3, or 4 fuel cells in electrical series and generating (respectively) voltages of 2, 3, and 4 V.

Top view 820 shows how the two types of assemblies are oriented. Type 1 assembly 800a and type 2 assembly 850 are connected to cell 802a so that the panels with the openings are connected to cell 802a. As such, both sides of cell 802a are exposed (e.g., the fuel electrode side of the fuel cell to the fuel chamber and the oxygen electrode side of the fuel cell to the air chamber). Similarly, type 1 assembly 800b and type 2 assembly 850 are connected to cell 802b so that both sides of the fuel cell are exposed.

FIG. 8C is a diagram showing an embodiment of two types of foldable assemblies connected to two fuel cells and folded to form air chambers and fuel chambers. FIG. 8C is a continuation of the example shown in FIG. 8B. In diagram 830, the assemblies and cells shown flat in FIG. 8B have been folded to form fuel chambers 832 and air chambers 834. In this example, tabs in the two types of assemblies are inserted into corresponding slots and are then bent and welded down to improve sturdiness. Other techniques for securing a tab to the surface of an assembly may be used, for example, sealant or glue.

Not shown from the view presented by diagram 830 is an opening at the bottom of air chambers 834 for fresh air access. In some embodiments, an air chamber has an opening on one side, such as the bottom, to accept fresh air from ports in the lining of a cookstove. In some embodiments, a fuel chamber has an opening on the opposite side, such as at the top, to accept fuel and contain it. In some embodiments, the structure of a fuel cell system is symmetric, such that if it is flipped over, the air and fuel chambers can be reversed. If the fuel cells are likewise symmetric, functionality of the fuel cell module will not be lost. This may be desirable because the module may be expected to last longer if, for instance, the most rapid degradation mode occurs in the air chamber, and the module is flipped back and forth between operation times so that none of the chambers functions as the air chamber during the entire lifetime of the device. In other words, each chamber experiences duty as an air chamber and as a fuel chamber.

Diagram 840 continues the example shown in diagram 830. In diagram 840, the example of fuel cell system 830 is continued with lids 842, electrical leads 844, and sealant 846 (around the perimeter of the fuel cells) connected. When folded and/or assembled (e.g., as in FIG. 8C), the volume is greater than when flat and/or not fully assembled (e.g., as in FIGS. 8A and 8B). Foldable assemblies may be desirable because it takes less space when stored and/or shipping costs are reduced (e.g., shipping costs increase with volume).

In one embodiment of a manufacturing process which incorporates foldable assemblies, the foldable assembles are fabricated from sheet metal. In various embodiments, this includes stamping, die cutting, laser cutting, or chemical etching. Bend lines are then formed on the foldable assemblies, for example by chemically etching or cutting into the sheet metal (e.g., with a saw, drill, or laser). The fuel cells are then connected to the assemblies while the assemblies are still flat. In various embodiments, this includes brazing, welding, resistance “spot” welding, laser welding, sintering, or other metal-to-metal joining techniques. The assemblies (with the fuel cell(s) attached) are then folded (e.g., along the fold lines) to create air/fuel chambers. (Alternatively, in some embodiments, the flat assemblies are folded to create the air/fuel chambers and then the fuel cells are attached to the assemblies in their folded shape.) Sealant may be added at a variety of points in the manufacturing process (e.g., before/after folding the assembly to form the air/fuel chambers).

In some embodiments, electrical leads are able to withstand the heat source environment and are thick enough and conductive enough to efficiently transfer power from a fuel cell system to the device being powered (e.g., a battery to store the power, a mobile phone being charged, a fan, a radio, or an LED light). In some embodiments, electrical leads are stiff or relatively rigid such that they do not unintentionally touch each other (causing short circuit). In some applications, rigid electrical leads are attractive for other reasons, for example because a device connected to the electrical leads is relatively light and can be positioned as desired and remain in that position (e.g., an LED light at the end of bendable but rigid electrical leads is positioned or directed to illuminate an area as desired). In one example, an electrical lead is made of stainless steel wire, approximately 0.1 inches thick.

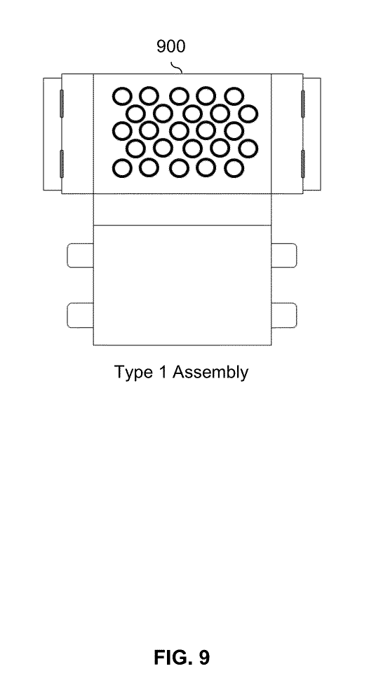

FIG. 9 is a diagram of a first type of a foldable assembly with a plurality of holes. In the example shown, type 1 assembly 900 includes a plurality of holes which match up to where a fuel cell is connected to the assembly. Assembly 900 is another embodiment of type 1 assembly 800 shown in FIGS. 8A-8B where a plurality of holes are used to exchange gaseous fuels (e.g., from a fuel chamber to a fuel electrode side of a fuel cell) or air (e.g., from an air chamber to an oxygen electrode side of a fuel cell) instead of a single opening as in FIGS. 8A-8B. (For brevity, a corresponding type 2 assembly with a plurality of holes is not shown.)

In some applications, using an assembly with a plurality of holes is desirable because of increased stiffness in the vicinity of the fuel cell. This may make it easier to bend sheet metal from a flat shape to a 3D shape without transferring stress to the fuel cell (e.g., in manufacturing processes where a fuel cell is attached to assembly 900 prior to folding of the assembly). Once assembled, a plurality of holes may also offer better structural integrity compared to a single, large opening. In some other embodiments, holes of different shapes are used, such as squares or hexagons. In some embodiments, a mesh lattice is used.

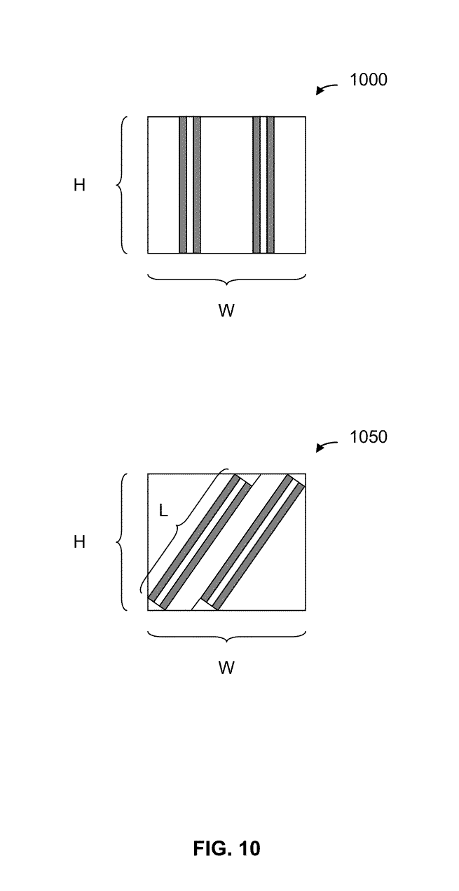

FIG. 10 is a diagram showing an embodiment of an assembly in which the fuel cells are orientated at an angle. In some embodiments, such an assembly is a foldable assembly. Diagrams 1000 and 1050 show side views of two fuel cell systems having the same height (H) and width (W). In diagram 1000, the two fuel cells are oriented vertically, and thus the length of the fuel cells is H. In diagram 1050, the two fuel cells are oriented at an angle (i.e., neither vertically nor horizontally) so that the length of the two fuel cells is L, where L is strictly greater than H (i.e., L>H). The size of the two fuel cells in diagram 1050 is therefore greater than that of the two fuel cells in diagram 1000. In some applications, having a larger fuel cell (e.g., for a given size of a fuel cell system) is desirable because electrical output increases with fuel cell size.

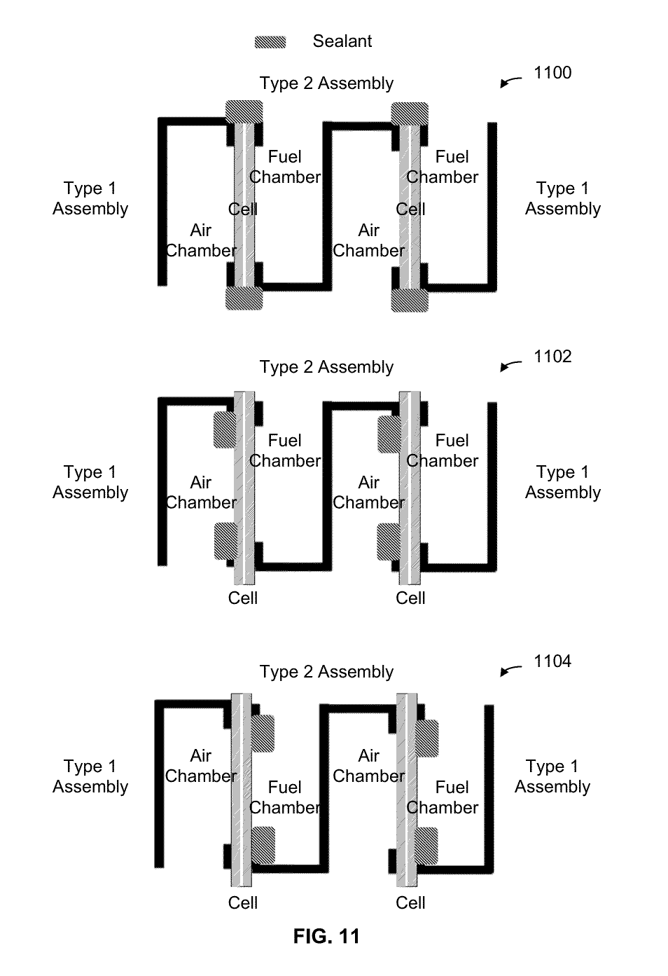

FIG. 11 is a diagram showing various embodiments of sealant placement used to attach fuel cells to two types of a flexible assembly. In some embodiments, sealant is used to minimize intermixing of gases between the fuel chamber, air chamber, and heat source environments. In some embodiments, a sealant increases structural strength at the perimeter or edge of a fuel cell. In some embodiments, a sealant is made of a material which is an electrical insulator and prevents a short circuit through or at the edges of a fuel cell. Although this figure and some previous figures show embodiments which use a sealant, a sealant is neither necessary nor required.

In diagram 1100, the sealant is connected to the fuel cell, the (walls of the) fuel chamber (made up at least in part by the second type of assembly), and the (walls of the) air chamber (made up at least in part by the first type of assembly). In diagram 1102, the sealant is connected to the fuel cell and the (walls of the) air chamber. In diagram 1104, the sealant is connected to the fuel cell and the (walls of the) fuel chamber. Combinations of the exemplary configurations and other configurations which are not shown herein are also possible.

As shown herein, in some embodiments, sealant is contained within the air chamber or fuel chamber (e.g., diagrams 1102 or 1104). In some applications this is desirable because it does not directly expose the sealant to the heat source environment which protects the sealant from being damaged by the heat or chemical species in a heat source environment (e.g., a fire). Alternatively, in some embodiments a sealant is made of a material which is able to withstand direct exposure to a heat source environment and sealant is located on the exterior of a fuel cell system (i.e., in direct contact with a heat source environment, as shown in diagram 1100).

In some cases, it may be desirable to have fuel cell system accessories which make using a fuel cell system more convenient and/or improve performance. The following figures describe an embodiment of a power conditioning removable attachment which is configured to be used with and connected to (e.g., electrically and/or physically) a fuel cell system.

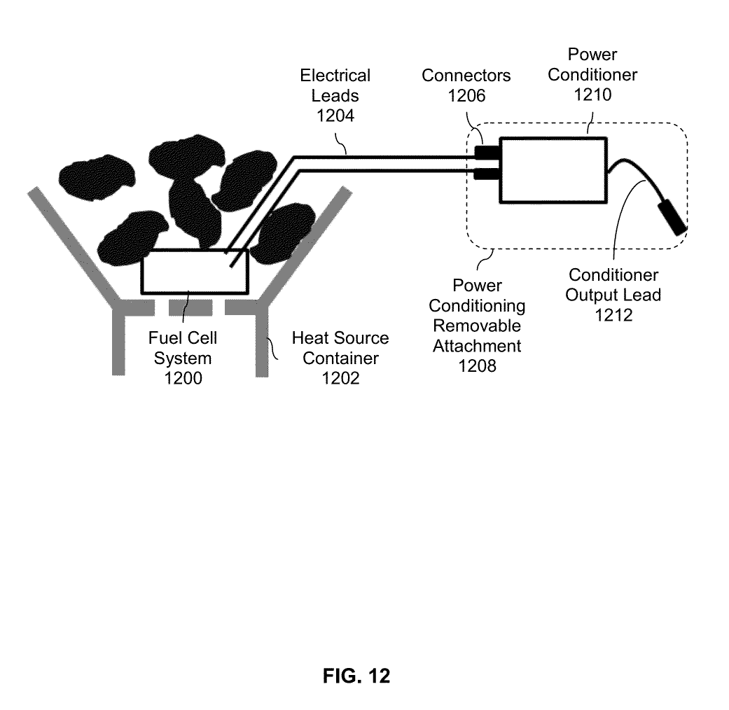

FIG. 12 is a diagram showing an embodiment of a power conditioning removable attachment which is connected to a fuel cell system. In the example shown, fuel cell system 1200 is at the bottom of heat source container 1202 in a heat source environment. Fuel cell system 1200 outputs electrical power via electrical leads 1204. Electrical leads 1204 are in turn connected to connectors 1206, which are part of power conditioning removable attachment 1208.

Power conditioning removable attachment 1208 includes connectors 1206, power conditioner 1210, and conditioner output lead 1212. Power conditioner 1210 conditions or otherwise transforms an input power signal so that its output power signal is not merely a (e.g., time shifted) copy of the input power signal. The following figure describes some examples of this. In some embodiments, conditioner output lead 1212 includes a two or three prong electrical socket, a light bulb socket for an LED light bulb, or a mini USB connector or other connector for charging a mobile telephone. In other embodiments, connectors 1206 and conditioner output lead 1212 are absent, for example when a device (e.g. LED light) built in to power conditioner 1210 consumes the power generated by the fuel cell assembly.

In some embodiments, power conditioning is achieved using one or more of the following components: a boost converter (also called a step-up converter), a buck-boost transformer, or a current limiting circuit. These types of circuits are exemplary and are not intended to be limiting.

In one example, a variety of attachments are sold, one of which is power conditioning removable attachment 1208. Another type of attachment may be a physical adapter (e.g., an adapter which has two connectors for electrical leads 1204 and a single output which is physically like conditioner output lead 1212) but does not perform the power conditioning of power conditioner 1210. In some embodiments, the cost of a non-power conditioning removable attachment is less than that of a power conditioning removable attachment. Offering different types of removable attachments at different prices and having different feature sets may be desirable so that users have a spectrum of price and feature options.

In some embodiments, an attachment acts as a handle. For example, power conditioner 1210 and/or conditioner output lead 1212 may be shaped or designed to fit into a user's hand (e.g., for carrying and/or supporting the fuel cell system 1200 for use at a location different from power production, such as removing it from a heat source environment to another area of the home or outdoors).

In some embodiments, electrical leads 1204 are long enough so that power conditioning removable attachment 1208 is far enough away from a hot zone that it remains cool enough to touch.

In some embodiments, an attachment includes an indicator or display to provide information or feedback to a user. Some examples include letting a user know when a fuel cell system is hot enough to generate electrical power (e.g., if a user wants to wait until the system is hot enough before inserting a fuel block in order to avoid wasting fuel, or so the user knows to increase the temperature by moving the fuel cell system to a hotter area, placing more burning charcoal in the vicinity of the fuel cell system, etc.), when power generation has (substantially) completed (e.g., because the heat source has cooled or because solid fuel in a fuel chamber has been substantially exhausted), when a device has been fully charged (e.g., because the device is no longer drawing power), when the fuel cell assembly needs to be replaced, when solid fuel in a fuel chamber needs to be replenished, the charge level of an internal battery, etc.

In some embodiments, an attachment includes some (e.g., built-in) components not shown herein. Some examples include a built-in light (e.g., an LED light so that the attachment can operate as a lamp or flashlight) or a battery (e.g., so the attachment can store power and at some later time charge or power a device). In some embodiments, a light is attached to a telescoping or extendable arm which is rigid but bendable (e.g. a gooseneck). When extended, the system may be used at a lamp. The extended arm may be adjusted to point in a desired direction or to be in a desired position. When retracted, the system may be used as a flashlight. In some embodiments, a battery included in an attachment is removable so that it can be used outside of the device (e.g., a AA rechargeable battery). Some example battery types (removable or otherwise) include NiMH, NiCd, lead acid, and Lithium. In some embodiments, an attachment includes a built-in fan (e.g., to blow fresh air at a cook stove or ventilate a tent).

In some embodiments, an attachment includes controls (e.g., switches or buttons) to put the attachment into a desired configuration or mode. For example, this may permit a user to select whether power is deployed immediately (e.g., to power a mobile phone or light bulb currently or already connected to conditioner output lead 1212) or saved for later use (e.g., in an internal battery in power conditioner 1210), whether power goes to an LED light or a battery built into power conditioning removable attachment 1208 (e.g., a “light on” mode versus a “charge internal battery” mode), and so on.

In some embodiments, an attachment includes one or more ports or connectors configured to transfer power to external devices, such as mobile phones, LED lights, fans, radios, and so on. In various embodiments, these ports or connectors are built-in and/or are removable (e.g., a variety of ports or connectors can be swapped out). Some examples include mini USB connectors and three-prong power outlets. In some embodiments, a variety of connectors associated with different parts of the world are able to be connected (e.g., North American-standard connectors, European-standard connectors, etc.). This enables fuel cell systems to be used all over the world (e.g., while camping in North America as well as in less developed parts of the world with unreliable or no power supply) and/or with electronics designed for different parts of the world.

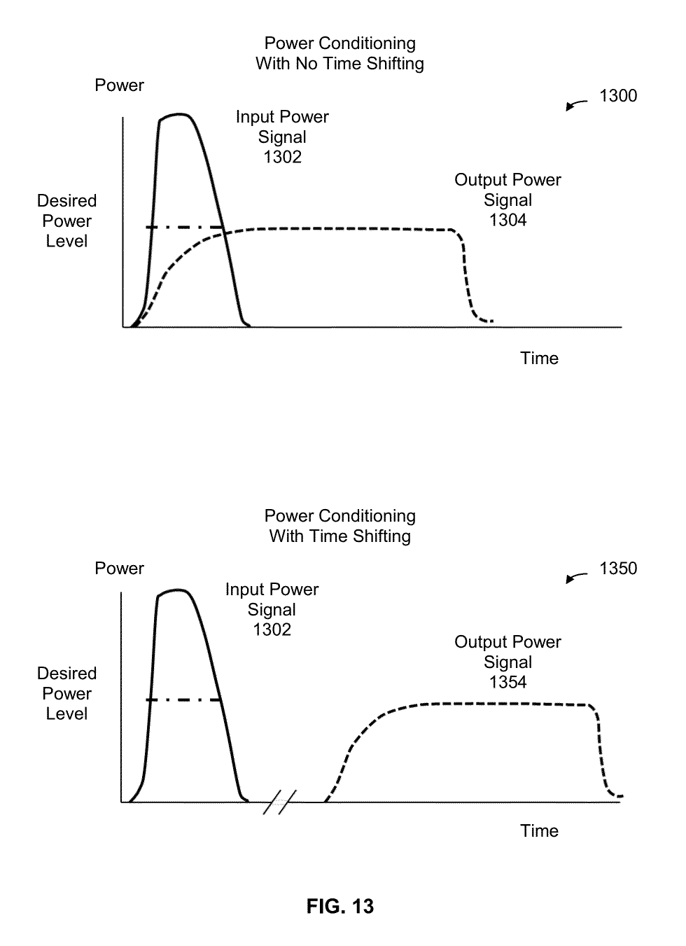

FIG. 13 is a diagram showing some embodiments of power conditioning. Diagram 1300 shows power conditioning without time shifting. In this example, input power signal 1302 is the power signal at the input of a power conditioner (e.g., the signal output by fuel cell system 1200 and input by power conditioner 1210 in FIG. 12). Output power signals 1304 and 1354 are associated with the output of a power conditioner (e.g., the signal at the output of power conditioner 1210 in FIG. 12).

In some cases, it is desirable for a fuel cell system to output a certain desired power level. For example, if an LED light bulb is being powered, a first power level may be desired. Alternatively, if a mobile telephone is being charged, a second power level is desired. In another example, it is desirable for a fuel cell system to be able to output one of a plurality of power levels associated with various regions of the world (e.g., because devices associated with different parts of the world expect different power levels).

Power conditioning smoothes out the input power signal so that the output power is provided at a steady, desired power level and the duration of time over which power is provided is extended. In some embodiments, the area under input power signal 1302 is substantially the same as output power signal 1304 (i.e., power conditioning is relatively power efficient and does not waste power). As a result of power conditioning, all of the power associated with output power signal 1304 is useable power and will not be wasted.

Diagram 1350 shows power conditioning with time shifting. In this example, a power conditioner includes an internal battery in which power (e.g., from input power signal 1302) is stored. After the internal battery is charged using input power signal 1302, an external device is connected to the charged internal battery (e.g., via conditioner output lead 1212 in FIG. 12) or an internal (on-board) device (e.g. LED light) is switched on. The internal battery in the power conditioner then outputs output power signal 1354 (e.g., to power a mobile telephone, an LED light, etc.).

The shape of input power signal 1302 is a result of the design of the fuel cell system and the uncontrolled (but flexible) environment in which the fuel cell system operates. Unlike some other fuel cell systems which operate in sealed environments where the temperature and the introduction of gaseous fuels is carefully controlled, the fuel cell system described herein is designed to be rugged and operate in a variety of environments, including outdoor environments which are not controlled. Heat sources for the fuel cell system described herein are difficult to control (e.g., it is difficult to control to a fine degree the temperature of a cook stove or other fire) and similarly the introduction of oxygen and gaseous fuels is less controlled (e.g., the environment is not sealed and purified gaseous fuels and purified oxygen stored in tanks are not available). As a result, whereas some other fuel cell systems are able to control the power signal output by a fuel cell system (e.g., by carefully adjusting the temperature and/or the flow rate of purified oxygen and/or purified gaseous fuels pumped into a sealed environment), the power signal generated by a fuel cell system is (for the most part) uncontrolled. The shape of input power signal 1302 (and its associated issues) is therefore a problem that some other fuel cell systems do not encounter.

In some embodiments, power conditioner 1210 in FIG. 12 is able to operate in both of the example power conditioning modes shown and determines which transformation to perform using a variety of techniques. In one example, a power conditioner uses an automatic selection technique. For example, power conditioning removable attachment 1208 may know when an external device is connected to conditioner output lead 1212. If something is connected to conditioner output lead 1212, then power conditioner 1210 automatically decides to perform power conditioning without time shifting (e.g., diagram 1300). If there is nothing connected to conditioner output lead 1212, then power conditioner 1210 automatically decides to perform power conditioning with time shifting (e.g., diagram 1350). In another example, a power conditioner uses a user-specified selection technique. For example, via a button or switch, a user may specify whether to perform power conditioning with or without time shifting.

In some embodiments, the level of an output power signal (e.g., 1304 or 1354) is able to be selected or adjusted. For example, a scientist may live in one region of the world where devices use one voltage level (e.g., North America, Europe, Japan, Africa, etc.) but does field work in another part of the world where a different voltage level is used. It may be desirable to be able to change voltage levels so that devices built for various regions may be supplied with the proper voltage level. The output voltage may also be selected or adjusted to match the operating voltage of various devices that might be connected to the power conditioner (e.g. LED operating around 3V or a Lithium battery recharging at around 5V).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a fuel cell having a fuel electrode and an oxygen electrode, wherein a side of the fuel cell associated with the fuel electrode is a fuel electrode side and a side of the fuel cell associated with the oxygen electrode is an oxygen electrode side;
a shield configured to be on the oxygen electrode side of the fuel cell;
an air chamber configured to be on the oxygen electrode side of the fuel cell, wherein the air chamber is formed at least in part by the shield; and
a fuel chamber configured to be on the fuel electrode side of the fuel cell, wherein the fuel chamber is configured to hold solid fuel.

2. The system of claim 1, wherein the shield includes one or more of the following: at least one opening on a top wall of the air chamber or at least one opening on a side wall of the air chamber.

3. The system of claim 1, wherein the fuel cell includes one or more of the following: a solid oxide fuel cell or a porous metal support.

4. The system of claim 1 further comprising one or more of the following: a battery, a light, a fan, an indicator, or a control.

5. The system of claim 1, wherein:
the fuel cell is a first fuel cell;
the fuel chamber is a first fuel chamber; and
the system further includes:
a second fuel cell having a fuel electrode and an oxygen electrode; and
a second fuel chamber configured to be on the fuel electrode side of the second fuel cell, wherein the air chamber is formed between the oxygen electrode side of the first fuel cell and the shield and between the oxygen electrode side of the second fuel cell and the shield.

6. The system of claim 1, wherein:
the fuel cell is a first fuel cell;
the shield is a first shield;
the air chamber is a first air chamber; and
the system further includes:
a second fuel cell having a fuel electrode and an oxygen electrode; and
a second shield configured to be on the oxygen electrode side of the second fuel cell, wherein a second air chamber is formed between the oxygen electrode side of the second fuel cell and the second shield.

7. The system of claim 1 further including a foldable assembly associated with at least the shield.

8. The system of claim 1 further including a first type of foldable assembly and a second type of foldable assembly.

9. The system of claim 1, wherein the fuel cell is oriented at an angle that is neither horizontal nor vertical.

10. The system of claim 1 further including a power conditioning attachment which is configured to power condition a power signal input to the power conditioning attachment.

11. The system of claim 10, wherein the power conditioning attachment is further configured to perform power conditioning with time shifting.

12. The system of claim 10, wherein the power conditioning attachment is removable.

13. The system of claim 1, wherein at least one of the following provides an electrical connection to the fuel cell: the shield, the air chamber, or the fuel chamber.
